(19) United States
(12) Patent Application Publication
(10) Pub. No.: US 2018/0141196 A1
(43) Pub. Date: May 24, 2018

(54) OIL FILTER EXTRACTOR TOOL

(71) Applicant: CHRIS BERNDT, SEBASTOPOL, CA (US)

(72) Inventor: CHRIS BERNDT, SEBASTOPOL, CA (US)

(21) Appl. No.: 15/358,451

(22) Filed: Nov. 22, 2016

(51) Int. Cl. B25B 27/00; B01D 29/96

(52) U.S. Cl. CPC B25B 27/0042; B01D 2201/24; B01D 29/96

(57) ABSTRACT

This invention relates to an oil filter extractor assembly for enabling the change of an oil filter. The oil filter extractor assembly for enabling the change of oil filter comprising: a first end having a handle means for threading the oil filter extractor assembly to the oil filter; a round plate; a second end having an external threads; and wherein the round plate presses against the seal of the oil filter to avoid spilling of the oil. The present invention provides an oil filter extractor assembly for changing the oil filter, which is easy to use & simple, safe, saving the time, manually operable, and avoiding any spillage of the oils on the vehicle or onto the ground.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

### (1) Field of the Invention

The present invention generally relates to the field of an oil filter extractor tools.

### (2) Background of the Invention

Oil is a lubricant that is utilized in an internal combustion engine. The oil functions are to lubricate the moving parts, provide protection against corrosion and help to cool the engine during usage. Internal combustion engines circulate oil through the engine to reduce friction between moving parts while the engine is in operation. During the circulation process, the oil accumulates debris and heats up from the heat dissipated from the engine. Oil filters are currently used to filter the lubricated oil. Oil filters are generally placed on the engine block. A typical motor vehicle engine includes an oil filter, which helps to clean some of the buildup or residue that develops in the oil over time. However, over time the residue and sludge diminishes the effectiveness of oil. Consequently, the oil needs to be periodically replaced as a regular maintenance activity associated with the operation of a vehicle. It is important to periodically change an oil filter so that it does not become clogged. Anyone who has changed the engine oil and oil filter in a motor vehicle will understand the challenge of removing an oil filter without spilling oil on a driveway or without having the oil run down one's arm. Further, this messy job is a recurring one. Consequently, it is necessary to have a catch basin under the oil filter while the oil filter is removed for changing.

A number of different type of the tools and methods for replacing/changing the oil filters are available in the prior art. The following prior art documents are related to oil filters and extraction, which are herein incorporated by reference for their supportive teachings, and include the following: U.S. Pat. No. 5,328,606 discloses a spin-on oil filter with extendible handle. The spin-on oil filter generally includes a tubular body housing a filtering element and a retractable, external handle that can be manually gripped and twisted for filter installation and removal. Prior art document US Pat. Appl. No. 2013/0206244 discloses an oil filter removal tool and system for the removal and drainage of an oil filter comprising: an oil drain connector, where said connector connects to an oil filter cap of the oil filter; a turn bolt at a distal end of the tool, where said bolt is used to turn the removal tool; a second turn bolt, where the second turn bolt turns counter clockwise to secure the connector to the filter cap; a drain tube provided at the distal end of the tool that inserts onto a drain plug; a body portion, where the body portion secures around the oil filter and surrounds the oil drain connector; and notches, where said notches are provided around a perimeter edge of the body portion of the removal tool. Another prior art document U.S. Pat. No. 5,623,755 discloses an adapter assembly to assist in the removal of an oil filter without spilling oil. The assembly includes a drain cup adapter for permanent affixing to the oil filter stud which extends from an engine block. Prior art document U.S. Pat. No. 5,000,847 discloses a spin-on type oil filter with an improvement to the normal filter body that allows non-tool assisted, easy hand installation and removal of the filter unit in open and close tolerance situations. The external closed end of the oil filter housing may be provided with at least a single centrally fixed rib, which serves as a handle. Yet other prior art documents U.S. Pat. No. 5,024,760 and U.S. Pat. No. 5,744,032 disclose an easily removable oil filter and an oil filter attachment having bracket type fins spaced around the circumference of the oil filter body. Prior art document U.S. Pat. No. 5,469,935 discloses a device for preventing leakage and spillage of fluids from a canister type oil filter during removal thereof from an engine block which is in the form of an annular elastomeric sleeve having an upper end and a lower end. The upper end has an opening adapted to fit over the exterior of an oil filter. The bottom end of the sleeve has an opening of lesser diameter than that of the upper end and the body of the sleeve adjacent the lower end has smooth contours and is of increased thickness relative to the body of the sleeve. Further, prior art document U.S. Pat. No. 8,911,620 discloses a spin-on adapter for a remote oil filter to provide additional cooling capability to the engine oil system which includes a unitary piece main body having edges, a base attached the main body, a step between the main body and the base, a first orifice and a second orifice extending throughout the main body, the step, and the base, and plurality of cooling fins protruding from the edges of the main body.

However, above mentioned references and many other similar references has one or more of the following shortcomings: a consuming more time; b complex tools; c risk factors such as burning the mechanics by the hot oils while using the tool; d requirement of the more supplies; e expensive; f contamination with the soil; g use of the adsorbent chemicals to clean the spilled oil; and h not manually operated.

The present application addresses the above mentioned concerns and short comings with regard to providing oil filter extractor assembly for enabling the change of an oil filter.

### SUMMARY OF THE INVENTION

In the view of the foregoing disadvantages inherent in the known oil filter changing tools/assembly now present in the prior art, the present invention provides oil filter extractor assembly for changing the oil filter. As such, the general purpose of the present invention, which will be described subsequently in greater detail, is to provide simple, easy to handle, relatively cheap oil filter extractor assembly for changing the oil filter which has all the advantages of the prior art and none of the disadvantages.

An object of the invention is to provide a first end having a handle means for threading the oil filter extractor assembly to the oil filter; a round plate, wherein a diameter of the round plate is more than 2.88 inches; a second end having an external threads; and wherein the round plate presses against the seal of the oil filter to avoid spilling of the oil.

Another object of the invention is to provide an oil filter extractor assembly for enabling the change of an oil filter, wherein the oil filter extractor assembly connects to the top of the oil filter.

Yet another object of the invention is to provide an oil filter extractor assembly for enabling the change of an oil filter, wherein the diameter of the round plate is 2.88 inch.

Another object of the invention is to provide an oil filter extractor assembly for enabling the change of an oil filter, wherein the second end having external threads which helps to fix the oil filter extractor assembly on the oil filter as a cap.

Another object of the invention is to provide an oil filter extractor assembly for enabling the change of an oil filter, wherein the oil filter extractor assembly is manually operated.

Another object of the invention is to provide an oil filter extractor assembly for enabling the change of an oil filter, wherein the handle enables pulling off the oil filter from a fender well.

Another object of the invention is to provide an oil filter extractor assembly for enabling the change of an oil filter, wherein the handle also enables placing back the oil filter through the fender well.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty that characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1A depicts schematic view illustrating one of the embodiments of this invention when the oil filter is connected with the oil filter extractor assembly.

FIG. 1B depicts the front view of the oil filter extractor assembly.

FIG. 1C depicts the bottom view of the oil filter extractor assembly.

### DETAILED DESCRIPTION OF THE INVENTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

In order to remove an old oil filter, tools such as a filter wrench that provides a contractible loop must be employed to grip and remove the filter. In many cases clearance will not permit use of such a wrench. Oftentimes it is necessary to resort to cruder methods to remove the filter. For example, a screwdriver or pry bar may be driven through the body of the filter to provide a lever to remove the filter. Many attempts have been made to alleviate the problems associated with oil filter removal and clearance around the oil filter. Some of these include accessories or tools to be used with an oil filter. Various devices have been explained in the prior art to assist home auto mechanics in their removal of oil filters from automotive engines to eliminate dripping and spilling of oil onto the ground or garage floor. Spillage often results in the oil running down the arm of the mechanic and soiling his clothing and also causes detrimental environmental pollution. Further, changing the old oil filters is also a complex process and requires good amount of time.

The currently adopted way of changing the oil filter includes the following steps: firstly drained the oil from the oil filter and then for removing the oil filter from the fender well one has to turn it sideways and pull it out. While doing this, the used oil which will be left over in the oil filter as the position of the oil filter is horizontal spills down the frame, onto the suspension and then onto the ground. The oil filter extractor solves the problem of the mess and spillage. Further, during the summer months in areas like Northern California vehicles heated up which in turn also heated up the oil if driver/mechanic tries to change the oil filter, in this situation then there are chances he/she get burned by the hot oil. Now-a-day's screw-on oil filters such as oil filters used in the Dodge diesel vehicles having Cummins engine available in the market are design in such a way that the whole oil filters can be removed without requirement of removing any of the components of the oil filters. The present invention provides an oil filter extractor assembly which is easy to use, simple, safe, saves the time, manually operable, and avoiding any spillage of the oils on the vehicle or onto the ground.

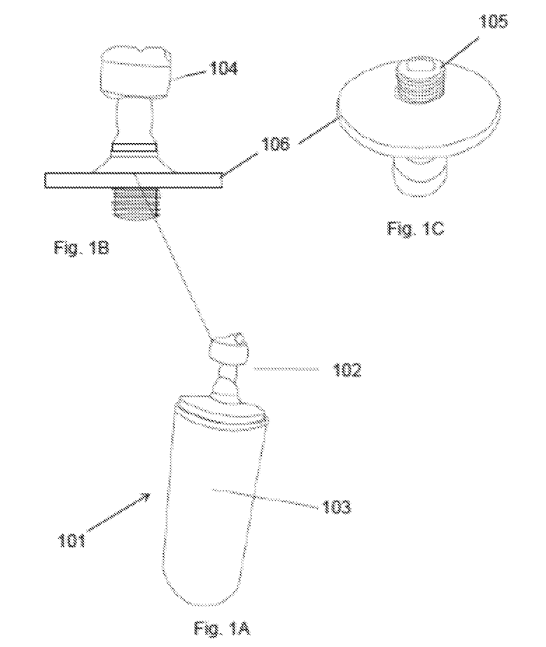

Referring to FIG. 1A, which shows one of the embodiments of this invention when the oil filter 101 is connected with the oil filter extractor assembly 102. Similarly, referring to FIG. 1B and FIG. 1C which shows respectively a front view and a bottom view of the oil filter extractor assembly 102.

As per the present invention, when the vehicle driver or mechanic notices that there is a need to change the oil filter, the second end having external threads 105 of the oil filter extractor assembly 102 will be connected to the top/head of the oil filter 101. The oil filter extractor assembly 102 caps off the oil filter 101. The oil extractor assembly 102 also includes a first end having a handle 104 and a round plate 106. The design of the handle can be of any different types and the handle may also include hole to drain the oil from the oil filter. At the time when the oil filter extractor assembly 102 connects with the oil filter 101, the round plate 106 of the oil filter extractor assembly 102 presses against the seal of the oil filter that helps in preventing oil leakage. The oil filters 101 capped off with the oil filter extractor assembly 102 can be easily removed through the fender well 103 using the handle 104. The process is reversed for the installation of the new oil filter in to the fender well 103. Changing the old oil filter with the new oil filter using the oil filter extractor assembly 102 can be easily performed manually without requirement of any other tool/supplies.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. An oil filter extractor tool, for enabling the change of an oil filter, comprising:
a) a first end having a handle means for threading the oil filter extractor assembly to the oil filter;
b) a round plate, wherein a diameter of the round plate is more than 2.88 inches;
c) a second end having external threads; and
wherein the round plate presses against the seal of the oil filter to avoid spilling of the oil.

2. The oil filter extractor tool according to claim 1, wherein the oil filter extractor assembly connects to the top of the oil filter.

3. The oil filter extractor tool according to claim 1, wherein the diameter of the round plate is 2.88 inch.

4. The oil filter extractor tool according to claim 1, wherein the second end having external threads which helps to fix the oil filter extractor assembly on the oil filter as a cap.

5. The oil filter extractor tool according to claim 1, wherein the oil filter extractor assembly is manually operated.

6. The oil filter extractor tool according to claim 1, wherein the handle enables pulling off the oil filter from a fender well.

7. The oil filter extractor tool according to claim 6, wherein the handle also enables placing back the oil filter through the fender well.
